(19) United States
(12) Patent Application Publication
(10) Pub. No.: US 2007/0179788 A1
(43) Pub. Date: Aug. 2, 2007

(54) Network support for interactive language lessons

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/341,068

(22) Filed: Jan. 27, 2006

(51) Int. Cl. G10L 11/00; G10L 21/00

(52) U.S. Cl. 704/270.1

(57) ABSTRACT

An apparatus in one example has: a mobile terminal having at least a display, audio input/output and a text entry part; a language server operatively coupled to a language lesson database; and a network operatively coupled to the mobile terminal and the language server.

### TECHNICAL FIELD

The invention relates generally to telecommunication networks, and more particularly to support various modes of language interaction.

### BACKGROUND

No matter what career a person chooses, if the person has learned a second language, the person will have a real advantage. A technician who knows Russian or German, the head of a company who knows Japanese or Spanish, or a salesperson who knows French or Chinese can work successfully with many more people and in many more places than someone who knows only one language.

There are lots of Americans who speak languages other than English. A person who, for example, is a nurse, a doctor, a police officer, a judge, an architect, a businessperson, a singer, a plumber, or a Webmaster, will multiply their chances for success if they speak more than one language. A hotel manager or a customer service representative who knows English and Spanish or English and Korean may look much better at promotion time than one who knows only English.

Professionals who know other languages are called on to travel and exchange information with people in other countries throughout their careers. Knowing more than one language enhances opportunities in government, business, medicine and health care, law enforcement, teaching, technology, the military, communications, industry, social service, and marketing. An employer will see such a person as a bridge to new clients or customers if they know a second language.

In fact, fluency in second and even third languages is rapidly becoming a requirement for many business people in today's global society. While there are numerous available options to learn a new language, all of them require dedicated classroom presence, or bulky textbooks, or inconvenient audio devices which must be carried. Currently, there are no viable alternatives for improving or maintaining second language fluency that are highly portable, interactive, and conducive to multiple learning modes.

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate cameras, electronic phonebooks, speed dialing, single button voicemail access, and messaging capabilities, such as e-mail.

It is a drawback of the prior art that language learning experiences are not offered in interactive portable devices that a user may already possess.

### SUMMARY

The invention in one implementation encompasses an apparatus. The apparatus in one embodiment may comprise: a mobile terminal having at least a display, audio input/output and a text entry part; a language server operatively coupled to a language lesson database; and a network operatively coupled to the mobile terminal and the language server.

The invention in a further implementation encompasses a method. The method in one embodiment may comprise: storing language lessons at a language server; and accessing, via a network, by a mobile terminal the stored language lessons at the language server.

### DESCRIPTION OF THE DRAWINGS

Features of exemplary implementations of the invention will become apparent from the description, the claims, and the accompanying drawings in which:

FIG. 1 is a representation of one implementation of an apparatus that enables a mobile telecommunications network to provide language lessons to a mobile terminal;

FIG. 2 is a representation of one exemplary flow diagram for providing language lessons to a mobile terminal according to the present method;

FIG. 3 is a representation of one embodiment of the language lesson database.

FIG. 4 is a representation of an exemplary flow diagram according to the present method.

FIG. 5 is a representation of another exemplary flow diagram according to the present method.

FIG. 6 is a representation of a further exemplary flow diagram according to the present method.

### DETAILED DESCRIPTION

Educators have long known engaging more senses in the learning process leads to both quicker mastery and better retention. Embodiments of the present method and apparatus optimize the language learning experience through offering the four modes of language use via a network as content source and a mobile handset as a language content exchange mechanism. In addition, because no additional equipment is required, the solution is highly portable and economical. Finally, the embodiments are particularly well suited to operate in the interrupt-driven mode that people often experience in today's environment.

One methodology of the embodiments of the present method and apparatus is for the network to access stored language lessons from a language server. Another methodology is for the network to transmit the second language to the mobile handset to allow the mobile subscriber to hear correctly spoken words and phrases from the language lesson. A further methodology is for the network to display written words and phrases from the language lesson on the screen of the mobile handset for viewing by the mobile subscriber. Yet another methodology is for the network to receive a mobile subscriber's pronunciation of words and phrases from the language lesson, to compare the received voice to the proper pronunciations stored in the language database, and to provide feedback to the mobile subscriber. Another methodology is for the network to receive text entered by the mobile subscriber in response to voice commands from the network to type specific words and phrases from the language lesson.

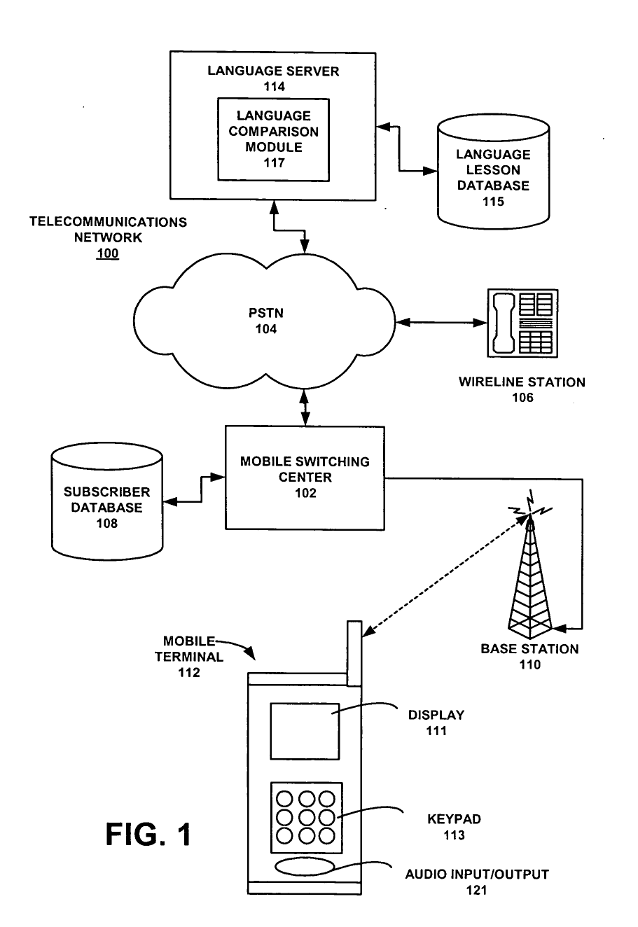

FIG. 1 is a representation of one implementation of an apparatus that enables a mobile telecommunications network to provide language lessons to mobile terminals of subscribers.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may be operatively coupled to, for example, a wireline station 106. The PSTN 104 may route calls to and from a mobile terminal 112 through the MSC 102. The MSC 102 may also be connected to at least one base station (BS) 110. The base station 110 communicates with the mobile terminal 112 in its service area using a subscriber database 108. The PSTN 104 generally may be implemented as a worldwide voice telephone network accessible to all those with telephones and access privileges (e.g., AT&T long distance network). The mobile terminal 112 may be any one of a number of devices, such as a cell phone, a personal data assistant (PDA), a laptop computer, etc. The mobile terminal 112 may have a display 111, an audio input/output 121, and a text entry part, such as keypad 113.

The PSTN 104 may also be operatively coupled to a language server 114 that is operatively coupled to a language lesson database 115. Words and phrases of at least one predetermined language, as well as lessons for learning the predetermined language, are stored in the language lesson database 115. The language server 114 may have a language comparison/analysis module 117, wherein the language comparison/analysis module 117 compares pronunciation of the predetermined words and phrases, received from the mobile terminal 112, to proper pronunciations of the words and phrases stored in the language lesson database 115.

Other types of networks, such as an IMS network may be used instead of the PSTN. Also, for example, the language server may be considered to be part of the network, or may be a separate entity that is operatively coupled to the network. Responses from the mobile terminal may be stored in the network or may be stored in a storage that is operatively coupled to the network.

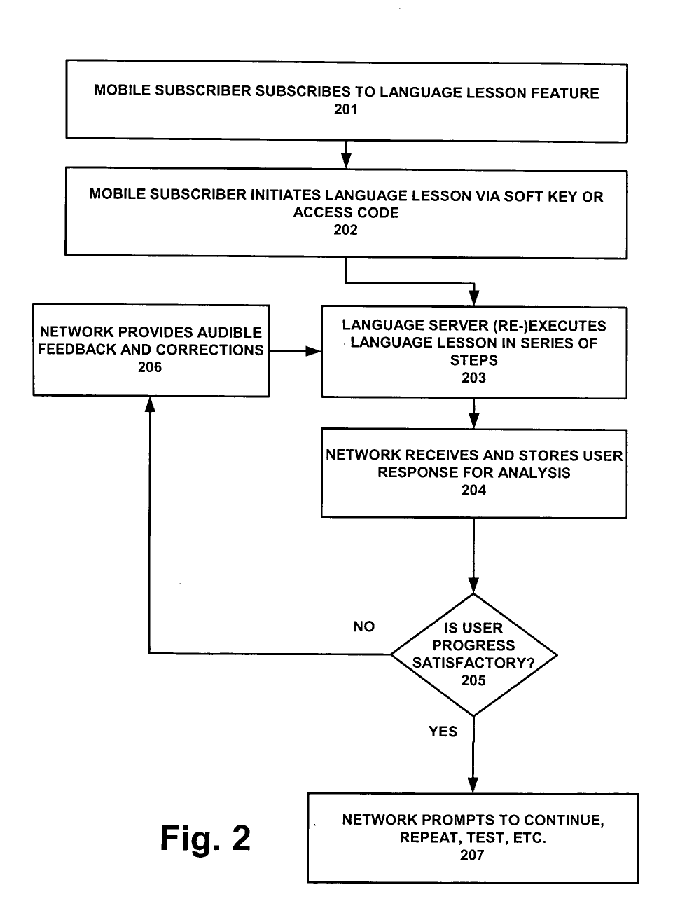

More specifically, as depicted in FIG. 2, initially a mobile subscriber subscribes to a language lesson feature (201). The mobile subscriber then initiates the language lesson via a soft key or access code from a mobile terminal (202). In response the language server executes a language lesson in a series of steps (203). The network receives and stores user responses for analysis (204). If the user progress in not satisfactory (205), then the network may provide audible feedback and corrections (206). If the user progress is satisfactory (205), then the network prompts to continue, repeat, test, etc. (207).

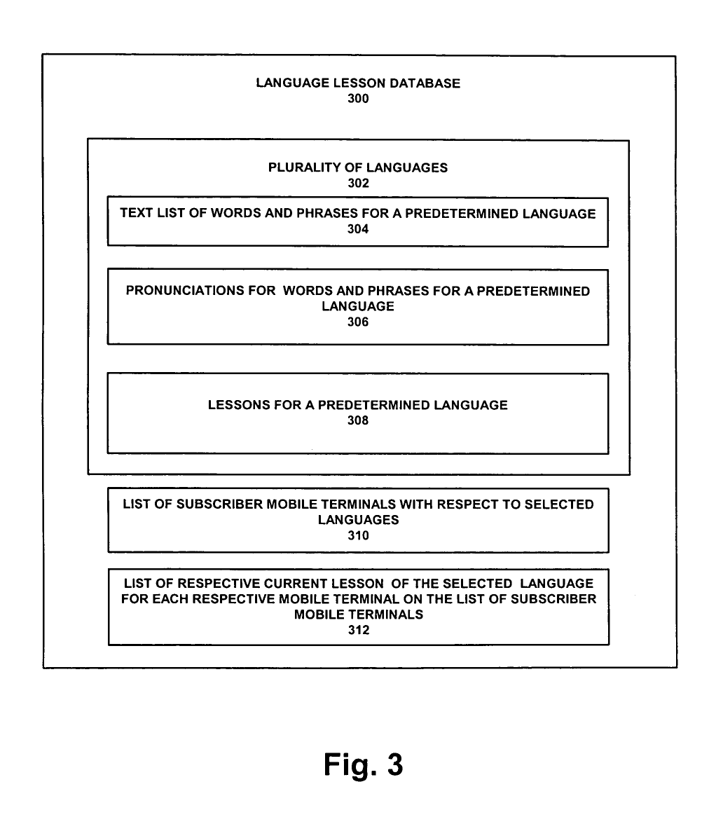

FIG. 3 is a representation of one embodiment of the language lesson database 300. Although many configurations are possible, in this embodiment the language lesson database 300 may have stored therein a plurality of different languages 302 in the form of a respective text list of words and phrases for each of the languages 304, respective pronunciations for the words and phrases for each of the languages 306, and respective lessons for the languages 308. The language database 300 may also have a list 310 of subscriber mobile terminals with respect to the selected languages. With this database the language server checks inputs from mobile terminals to determine if they are authorized subscribers to this service. The language database 300 may further have a list 312 of the respective current lesson of the selected language for each respective mobile terminal on the list of subscriber mobile terminals. With this list 312 the language server may send the correct current lesson to a mobile terminal that when the language server receives a request from the mobile terminal.

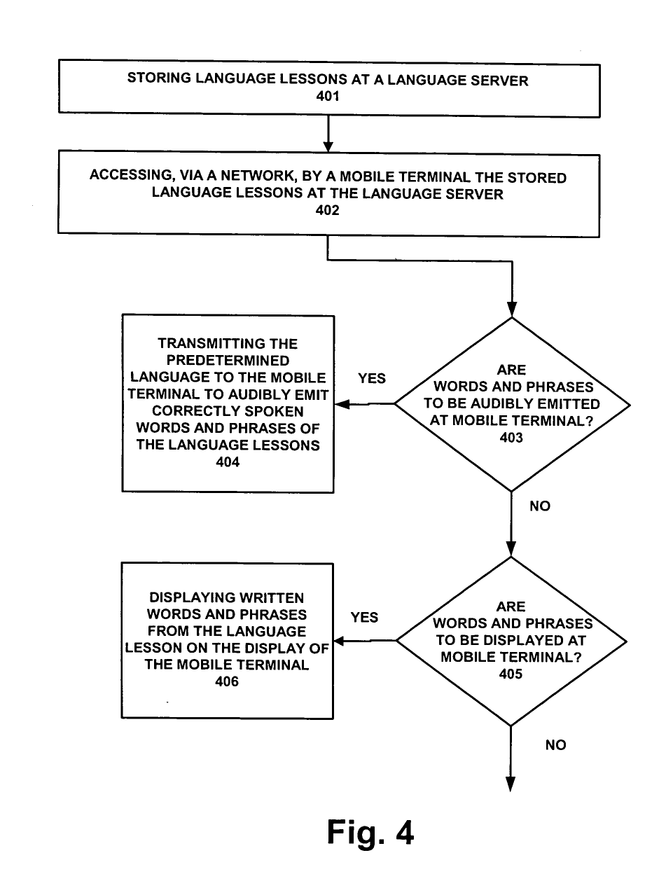

FIG. 4 is a representation of one exemplary flow diagram for language interaction according to the present method. This embodiment of the present method may have the steps of: storing language lessons at a language server (401); accessing, via a network, by a mobile terminal the stored language lessons at the language server (402); are words and phrases to be audibly emitted at the mobile terminal? (403): if the words and phrases are to be audibly emitted at the mobile terminal, transmitting the predetermined language to the mobile terminal to audibly emit correctly spoken words and phrases of the language lessons (404); are words and phrases to be displayed at the mobile terminal? (405); and if the words and phrases are to be displayed at the mobile terminal, displaying written words and phrases from the language lesson on the display of the mobile terminal (406).

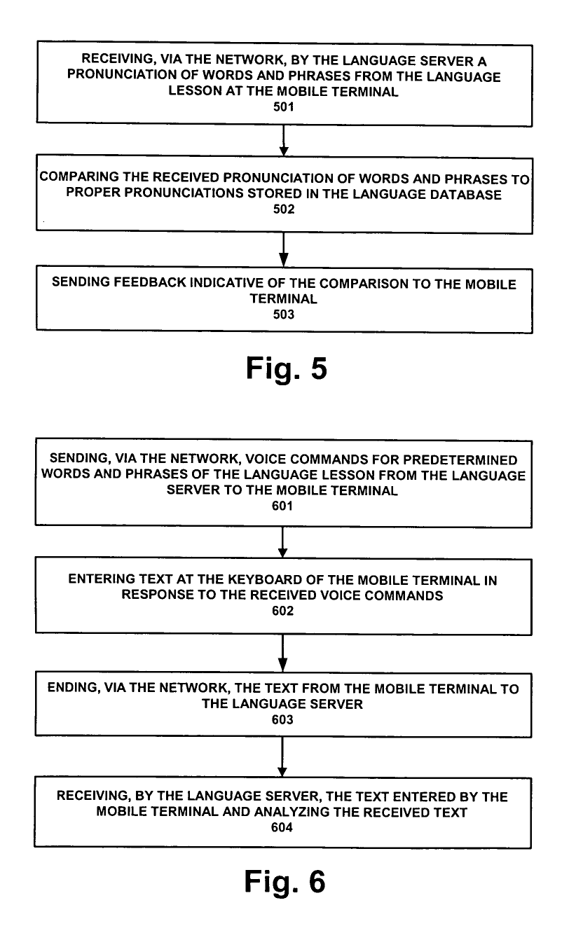

FIG. 5 is a representation of another exemplary flow diagram for language interaction according to the present method. This embodiment of the present method may have the steps of: receiving, via the network, by the language server a pronunciation of words and phrases from the language lesson at the mobile terminal (501); comparing the received pronunciation of words and phrases to proper pronunciations stored in the language database (502); and sending feedback indicative of the comparison to the mobile terminal (503).

FIG. 6 is a representation of another exemplary flow diagram for language interaction according to the present method. This embodiment of the present method may have the steps of: sending, via the network, voice commands for predetermined words and phrases of the language lesson from the language server to the mobile terminal (601); entering text at the keyboard of the mobile terminal in response to the received voice commands (602); ending, via the network, the text from the mobile terminal to the language server (603); receiving, by the language server, the text entered by the mobile terminal and analyzing the received text (604).

Embodiments of the present method and apparatus overcome the drawbacks of the prior art and enables the mobile telecommunications network to gain access to language learning expenences.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising:
storing language lessons at a language server; and
accessing, via a network, by a mobile terminal the stored language lessons at the language server.

2. The method according to claim 1, wherein the stored language lessons are for at least one predetermined language, and wherein the method further comprises transmitting the predetermined language to the mobile terminal to audibly emit correctly spoken words and phrases of the language lessons.

3. The method according to claim 2, wherein the mobile terminal has a display, and wherein the method further comprises displaying written words and phrases from the language lesson on the display of the mobile terminal.

4. The method according to claim 3, wherein the network has a language server operatively coupled to a language database, and wherein the method further comprises:
receiving, via the network, by the language server a pronunciation of words and phrases from the language lesson at the mobile terminal;
comparing the received pronunciation of words and phrases to proper pronunciations stored in the language database; and
sending feedback indicative of the comparison to the mobile terminal.

5. The method according to claim 4, wherein the mobile terminal has a keyboard for entering text, and wherein the method further comprises:
sending, via the network, voice commands for predetermined words and phrases of the language lesson from the language server to the mobile terminal;
entering text at the keyboard of the mobile terminal in response to the received voice commands;
sending, via the network, the text from the mobile terminal to the language server; and
receiving, by the language server, the text entered by the mobile terminal and analyzing the received text.

6. An apparatus, comprising:
a mobile terminal having at least a display, audio input/output and a text entry part;
a language server operatively coupled to a language lesson database; and
a network operatively coupled to the mobile terminal and the language server.

7. The apparatus according to claim 6, wherein the language server has a language comparison/analysis module, wherein predetermined words and phrases of a predetermined language are input at the mobile terminal using the audio input/output, and wherein the language comparison/analysis module compares pronunciation of the predetermined words and phrases, received from the mobile terminal, to proper pronunciations of the words and phrases stored in the language lesson database.

8. The apparatus according to claim 6, wherein predetermined words and phrases for a predetermined language are stored in the language lesson database, and wherein the predetermined words and phrases are displayed on the display of the mobile terminal.

9. The apparatus according to claim 6, wherein predetermined words and phrases for a predetermined language are stored in the language lesson database, and wherein the predetermined words and phrases are broadcast from the audio input/output of the mobile terminal.

10. The apparatus according to claim 6, wherein predetermined words and phrases for a predetermined language are stored in the language lesson database, and wherein the predetermined words and phrases are broadcast from the audio input/output of the mobile terminal.

11. The apparatus according to claim 6, wherein the language server has a language comparison/analysis module, wherein predetermined words and phrases of a predetermined language input at the mobile terminal using the text entry part, and wherein the language comparison/analysis module evaluates the text entered predetermined words and phrases, received from the mobile terminal.

12. An apparatus, comprising:
means for storing language lessons at a language server; and
means for accessing, via a network, by a mobile terminal the stored language lessons at the language server.

13. The apparatus according to claim 12, wherein the stored language lessons are for at least one predetermined language, and wherein the apparatus further comprises means for audibly emitting correctly spoken words and phrases of the language lessons at the mobile terminal.

14. The apparatus according to claim 12, wherein the mobile terminal has a display, and wherein the apparatus further comprises means for displaying written words and phrases from the language lesson on the display of the mobile terminal.

15. The apparatus according to claim 12, wherein the language server has a language comparison/analysis module, wherein predetermined words and phrases of a predetermined language are input at the mobile terminal using the audio input/output, and wherein the language comparison/analysis module compares pronunciation of the predetermined words and phrases, received from the mobile terminal, to proper pronunciations of the words and phrases stored in the language lesson database.

16. The apparatus according to claim 12, wherein predetermined words and phrases for a predetermined language are stored in the language lesson database, and wherein the predetermined words and phrases are broadcast from the audio input/output of the mobile terminal.

17. A method, comprising:
subscribing by a mobile terminal to a language lesson feature on a network;
initiating by the mobile terminal the language lesson via one of a soft key or access code from a mobile terminal;
executing a language lesson by a language server for the mobile terminal;
receiving and storing by the network user responses for analysis;
providing audible feedback and corrections by the network to the mobile terminal, if user progress on the mobile terminal is not satisfactory;
prompting to continue, repeat, test by the network, if user progress is satisfactory.

18. The method according to claim 17, wherein the method further comprises:
storing language lessons at a language server that is operatively coupled to the network; and
accessing, via the network, by the mobile terminal the stored language lessons at the language server.

19. The method according to claim 18, wherein the stored language lessons are for at least one predetermined language.

20. The method according to claim 17, wherein the method further comprises storing respective language lessons for a plurality of different predetermined languages.
